(19) United States
(12) Patent Application Publication
(10) Pub. No.: US 2025/0229179 A1
(43) Pub. Date: Jul. 17, 2025

(54) METHOD AND APPARATUS FOR ADJUSTING VIDEO PROGRESS, COMPUTER DEVICE AND STORAGE MEDIUM

(71) Applicant: NETEASE (HANGZHOU) NETWORK CO., LTD., Hangzhou (CN)

(72) Inventor: Junyong CUI, Hangzhou (CN)

(21) Appl. No.: 18/837,838

(22) PCT Filed: Mar. 1, 2023
(86) PCT No.: PCT/CN2023/079102

§ 371 Date: Apr. 7, 2025

(30) Foreign Application Priority Data
Jun. 24, 2022 (CN) 202210729352.5

(51) Int. Cl. A63F 13/537; A63F 13/803; A63F 13/86

(52) U.S. Cl. CPC A63F 13/537; A63F 13/803; A63F 13/86

(57) ABSTRACT

The present disclosure provides a method for adjusting a video progress. A global thumbnail map is provided on a video playback interface. A game video including a virtual object running on a virtual race track is displayed on the video playback interface. A thumbnail map for the virtual race track is displayed on the video playback interface. A target playback progress of a game video is determined in response to a location selection operation on the thumbnail map, and on the basis of a target location selected by the location selection operation. A playback progress of the game video is adjusted to the target playback progress.

The present disclosure is a 371 national phase application of PCT Application No. PCT/CN2023/079102 filed Mar. 1, 2023, which claims priority to Chinese Patent Application No. 202210729352.5 filed with the Chinese Patent Office on Jun. 24, 2022, entitled “METHOD AND APPARATUS FOR ADJUSTING VIDEO PROGRESS, COMPUTER DEVICE, AND STORAGE MEDIUM”, the entire contents of both of which applications are hereby incorporated by reference for all purposes.

### TECHNICAL FIELD

The present disclosure relates to the technical field of computers, and relates specifically to a method and apparatus for adjusting a video progress, a computer device, and a storage medium.

### BACKGROUND ART

With the development of the Internet, a large number of different types of games have been provided to meet the daily entertainment needs of users.

With the continuous development of network technologies and terminal devices, the population of users who use terminal devices to watch videos is increasing. When using a terminal device to watch a video, a user can drag a progress bar in a video playback window to adjust the playback progress of the video, and jump to a corresponding video progress segment to watch the video.

### SUMMARY OF THE INVENTION

According to a first aspect, the present disclosure provides a method for adjusting a video progress. The method comprises: providing a video playback interface; displaying, on the video playback interface, a game video including a virtual object running on a virtual race track; displaying a thumbnail map for the virtual race track on the video playback interface; determining, in response to a location selection operation on the thumbnail map, and on the basis of a target location selected by the location selection operation, a target playback progress of the game video; and adjusting a playback progress of the game video to the target playback progress.

According to a second aspect, the present disclosure further provides a system. The system comprises one or more processors and one or more memories, the memory storing a plurality of computer-executable instructions. The one or more processors execute the instructions to perform the operations in the above method for adjusting a video progress.

According to a third aspect, the present disclosure further provides a non-transitory computer-readable storage medium, wherein the computer-readable storage medium stores a plurality of instructions, and the instructions are adapted to be loaded by one or more processors, to perform the operations in the above method for adjusting a video progress.

### BRIEF DESCRIPTION OF THE DRAWINGS

To more clearly illustrate the technical solutions in the embodiments of the present disclosure, the drawings required for use in the description of the embodiments will be briefly described below, and it is obvious that the drawings in the following description are only some embodiments of the present disclosure, and for those skilled in the art, other drawings can also be obtained from these drawings without any inventive effort.

FIG. 1 is a schematic flowchart of a method for adjusting a video progress according to an embodiment of the present disclosure.

FIG. 2 is a schematic diagram of an application scenario of a method for adjusting a video progress according to an embodiment of the present disclosure.

FIG. 3 is a schematic diagram of an application scenario of another method for adjusting a video progress according to an embodiment of the present disclosure.

FIG. 4 is a schematic diagram of an application scenario of another method for adjusting a video progress according to an embodiment of the present disclosure.

FIG. 5 is a schematic diagram of an application scenario of another method for adjusting a video progress according to an embodiment of the present disclosure.

FIG. 6 is a schematic diagram of an application scenario of another method for adjusting a video progress according to an embodiment of the present disclosure.

FIG. 7 is a schematic diagram of an application scenario of another method for adjusting a video progress according to an embodiment of the present disclosure.

FIG. 8 is a schematic diagram of an application scenario of another method for adjusting a video progress according to an embodiment of the present disclosure.

FIG. 9 is a schematic diagram of an application scenario of another method for adjusting a video progress according to an embodiment of the present disclosure.

FIG. 10 is a schematic flowchart of another method for adjusting a video progress according to an embodiment of the present disclosure.

FIG. 11 is a schematic diagram of an application scenario of another method for adjusting a video progress according to an embodiment of the present disclosure.

FIG. 12 is a schematic flowchart of another method for adjusting a video progress according to an embodiment of the present disclosure.

FIG. 13 is a schematic diagram of an application scenario of another method for adjusting a video progress according to an embodiment of the present disclosure.

FIG. 14 is a schematic flowchart of another method for adjusting a video progress according to an embodiment of the present disclosure.

FIG. 15 is a schematic diagram of an application scenario of another method for adjusting a video progress according to an embodiment of the present disclosure.

FIG. 16 is a structural block diagram of an apparatus for adjusting a video progress according to an embodiment of the present disclosure.

FIG. 17 is a schematic structural diagram of a computer device according to an embodiment of the present disclosure.

### DETAILED DESCRIPTION

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The technical solutions in the embodiments of the present disclosure will be clearly and completely described below with reference to the drawings in the embodiments of the present disclosure. It is obvious that the described embodiments are only a part of the embodiments of the present disclosure, but not all of the embodiments. All other embodiments obtained by those skilled in the art on the basis of the embodiments of the present disclosure without any inventive effort shall still fall within the scope of protection of the present disclosure.

The embodiments of the present disclosure provide a method and apparatus for adjusting a video progress, a storage medium, and a computer device. Specifically, the method for adjusting a video progress according to an embodiment of the present disclosure may be performed by a computer device, wherein the computer device may be a device such as a terminal or a server. The terminal may be a terminal device such as a smart phone, a tablet computer, a notebook computer, a touch screen, a game console, a personal computer (PC), or a personal digital assistant (PDA). The terminal may further include a client, and the client may be a game application client, a browser client carrying a game program, an instant messaging client or the like. The server may be an independent physical server, a server cluster or a distributed system formed by a plurality of physical servers, or a cloud server that provides basic cloud computing services such as cloud services, cloud databases, cloud computing, cloud functions, cloud storage, network services, cloud communication, middleware services, domain name services, security services, CDNs, and large data and artificial intelligence platforms.

For example, the computer device may be a server. The server may be configured to: provide a video playback interface; display, on the video playback interface, a game video including a virtual object running on a virtual race track; display a thumbnail map for the virtual race track on the video playback interface; and determine, in response to a location selection operation on the thumbnail map, and on the basis of a target location selected by the location selection operation, a target playback progress of the game video, and adjust a playback progress of the game video to the target playback progress.

In view of the above problem, the embodiments of the present disclosure provide a first method and apparatus for adjusting a video progress, a computer device, and a computer-readable storage medium, which may improve game experience of a game player in an escape-room game.

Each will be described in detail below. It should be noted that the description order of the following embodiments is not intended to limit the preferred order of the embodiments.

An embodiment of the present disclosure provides a method for adjusting a video progress. The method may be performed by a terminal or a server, and the embodiment of the present disclosure will be described using an example in which the method for adjusting a video progress is performed by a server.

Embodiments of the present disclosure provide a method and apparatus for adjusting a video progress, a computer device, and a storage medium, which can solve the problem in which a user, when dragging a progress bar to adjust a video progress, needs to drag the progress bar repeatedly to achieve the desired adjustment progress, thereby wasting significant time in adjusting the progress, and resulting in low efficiency in video progress adjustment.

In the embodiments of the present disclosure, the global thumbnail map is provided on the video playback interface, and the target playback progress of the game video is determined by the touch operation of the user on the video playback interface, the video playback progress bar, or the global thumbnail map, so that the current video playback progress is adjusted on the basis of the target playback progress, helping the user to quickly navigate to a video segment that the user wants to watch, and improving the efficiency of video progress adjustment.

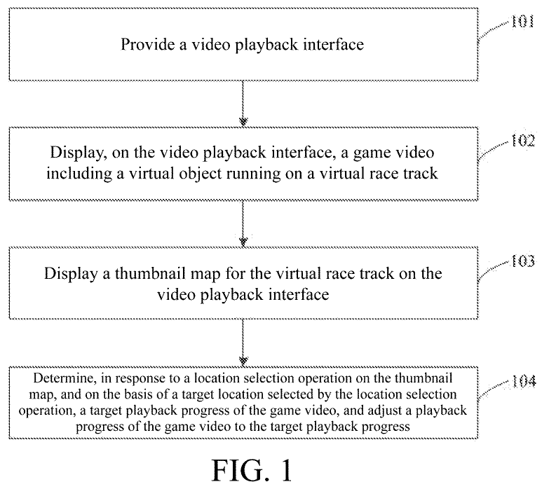

Referring to FIG. 1, FIG. 1 is a schematic flowchart of a method for adjusting a video progress according to an embodiment of the present disclosure. The specific process of the method for adjusting a video progress may be as follows:

101: A video playback interface is provided.

The video playback interface is used to display a video.

102: A game video including a virtual object running on a virtual race track is displayed on the video playback interface.

Specifically, the video playback interface includes a game video in which the virtual object runs on the virtual race track.

In the embodiment of the present disclosure, the game video refers to a video in which the virtual object participates in a target game. The target game may be a racing game having a starting point and an ending point, for example, a running race, a car race, etc. The target game may be an online game, an offline game, or the like. The virtual object may be a person or an object with the ability to move.

103: A thumbnail map for the virtual race track is displayed on the video playback interface.

A location view triggering operation is used to trigger the display of the thumbnail map on the video playback interface, and the thumbnail map indicates the virtual race track of the virtual object in the game in the game video. The virtual race track may be a trajectory from the starting point to the ending point in the target game.

In some embodiments, to enable a user to easily perform an adjusting operation on the video, the step of “displaying a thumbnail map for the virtual race track on the video playback interface” may include the following operations:
displaying, in response to a touch operation on the video playback interface, a playback progress bar on the video playback interface; and
displaying, in response to a touch operation on the playback progress bar, the thumbnail map on the video playback interface.

The touch operation on the video playback interface may be an operation such as clicking, sliding, and/or pressing. The playback progress bar may be used by the user to adjust the video playback progress.

The touch operation on the playback progress bar may be an operation such as clicking, sliding, and/or pressing.

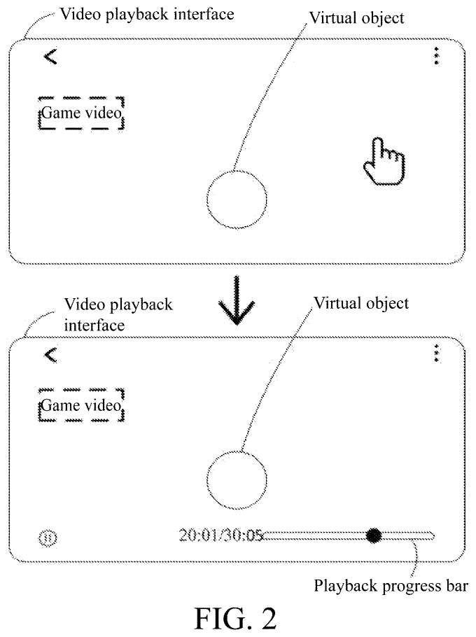

For example, referring to FIG. 2, FIG. 2 is a schematic diagram of an application scenario of a method for adjusting a video progress according to an embodiment of the present disclosure. A virtual object and a game screen of the virtual object are displayed on a video playback interface as shown in FIG. 2. When a touch operation of a user on a game video interface is detected, a playback progress bar is displayed on the game video interface, and a current video playback progress is displayed on the playback progress bar.

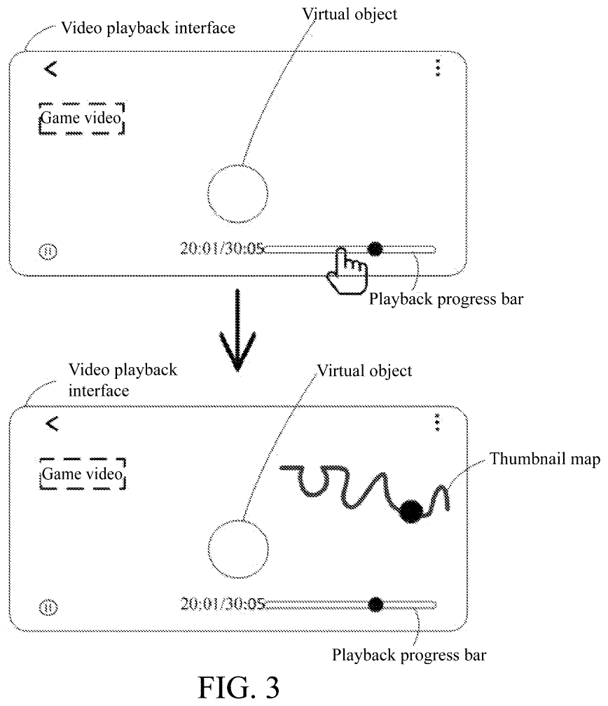

Further, referring to FIG. 3, FIG. 3 is a schematic diagram of an application scenario of another method for adjusting a video progress according to an embodiment of the present disclosure. A playback progress bar is displayed on a video playback interface as shown in FIG. 3. When a touch operation of a user on the playback progress bar is detected, a thumbnail map is displayed on the video playback interface, and the location of a game scene where a virtual object is currently located on the thumbnail map is displayed on the thumbnail map.

In some embodiments, to enable a user to easily perform an adjusting operation on the video, the step of “displaying a thumbnail map for the virtual race track on the video playback interface” may include the following operation:
displaying a thumbnail map for the virtual race track on the video playback interface, including:
displaying, in response to a touch operation on a location control, the thumbnail map on the video playback interface.

The video playback interface may include the location control, and the location control is used to trigger the display of the thumbnail map on the video playback interface.

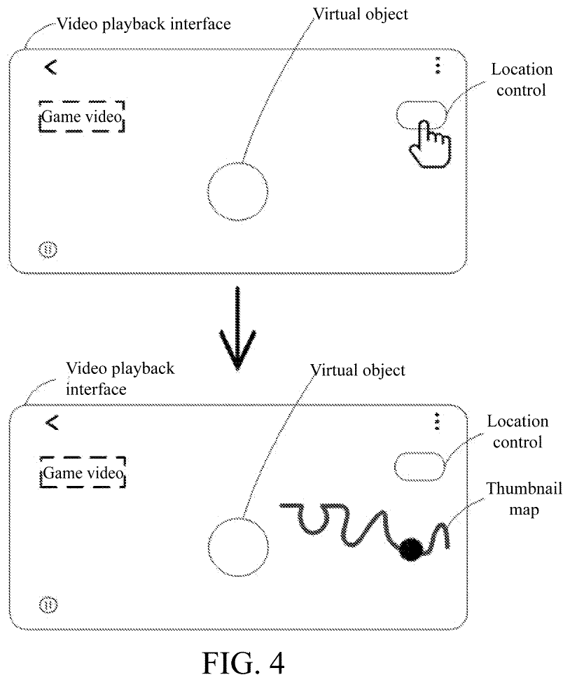

For example, referring to FIG. 4, FIG. 4 is a schematic diagram of an application scenario of another method for adjusting a video progress according to an embodiment of the present disclosure. A virtual object, a game screen of the virtual object, and a location control are displayed on a video playback interface as shown in FIG. 4. When a touch operation of a user on the location control is detected, a thumbnail map is displayed on the video playback interface, and the location of a game scene where the virtual object is currently located on the thumbnail map is displayed on the thumbnail map.

In some embodiments, to enable a user to easily perform an adjusting operation on the video, the step of “displaying a thumbnail map for the virtual race track on the video playback interface” may include the following operation:
displaying, in response to a touch operation on the video playback interface, the thumbnail map on the video playback interface.

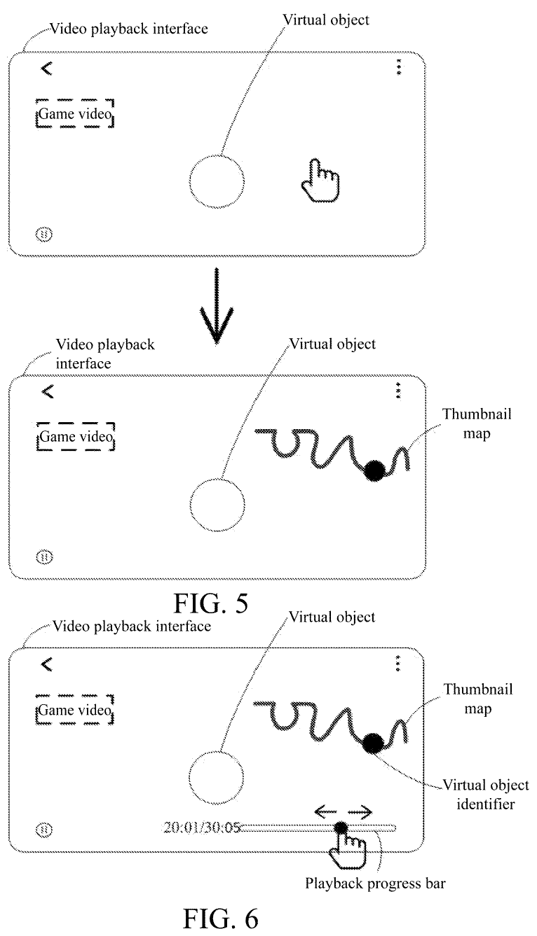

For example, referring to FIG. 5, FIG. 5 is a schematic diagram of an application scenario of another method for adjusting a video progress according to an embodiment of the present disclosure. A virtual object and a game screen of the virtual object are displayed on a video playback interface as shown in FIG. 5. When a touch operation of a user on the video playback interface is detected, a thumbnail map is displayed on the video playback interface, and the location of a game scene where the virtual object is currently located on the thumbnail map is displayed on the thumbnail map.

104: A target playback progress of the game video is determined in response to a location selection operation on the thumbnail map, and on the basis of a target location selected by the location selection operation, and a playback progress of the game video is adjusted to the target playback progress.

The location selection operation is used to select a target location on the thumbnail map, and the playback progress of the game video is determined by means of a game scene corresponding to the target location.

In some embodiments, to improve the accuracy of adjusting the video playback progress, the step of “determining, in response to a location selection operation on the thumbnail map, and on the basis of a target location selected by the location selection operation, a target playback progress of the game video” may include the following operations:
determining, in response to a touch operation on the playback progress bar, a target location of a virtual object identifier on the thumbnail map; and
acquiring a playback progress corresponding to the virtual object identifier at the target location in the game video, to obtain the target playback progress.

The virtual object identifier is displayed on the thumbnail map, and the location of the virtual object identifier on the thumbnail map corresponds to the location of the virtual object on the virtual race track.

For example, referring to FIG. 6, FIG. 6 is a schematic diagram of an application scenario of another method for adjusting a video progress according to an embodiment of the present disclosure. A virtual object, a game screen of the virtual object, a thumbnail map on which a virtual object identifier is displayed, and a playback progress bar are displayed on a video playback interface as shown in FIG. 6. A user may perform a slide operation on the playback progress bar, thereby controlling the target location of the virtual object identifier on the thumbnail map.

In some embodiments, to facilitate user operation, the touch operation on the playback progress bar may be a slide operation, that is, a first slide operation, and the step of “determining, in response to a touch operation on the playback progress bar, the target location of the virtual object identifier on the thumbnail map” may include the following operations:
acquiring, in response to the first slide operation on the playback progress bar, a slide direction and a slide distance of the first slide operation;
acquiring a current location of the virtual object identifier on the thumbnail map; and
adjusting the current location on the basis of the slide direction and the slide distance of the first slide operation, to obtain the target location.

For example, on the video playback interface as shown in FIG. 6, the first slide operation of the user on the playback progress bar is detected. The slide direction of the first slide operation may be rightward, and the slide distance may be 1 cm.

In an embodiment of the present disclosure, a corresponding relationship between the slide distance of the first slide operation on the playback progress bar and a moving distance of the virtual object identifier on the thumbnail map (that is, a calculation formula of the moving distance) may be set in advance, for example, moving distance=slide distance×(total length of thumbnail map/total length of playback progress bar), and the moving distance may be calculated according to the slide distance and the above calculation formula.

Further, the current location of the virtual object identifier on the thumbnail map is moved according to the slide direction and the moving distance, so that the target location of the virtual object identifier on the thumbnail map may be obtained.

Specifically, for the playback progress corresponding to the virtual object identifier at the target location in the game video, a target playback progress may be determined according to a game progress of the virtual object at a game scene corresponding the target location.

In some embodiments, to improve the accuracy of adjusting the video progress, the step of “determining, in response to a location selection operation on the thumbnail map, and on the basis of a target location selected by the location selection operation, a target playback progress of the game video” may include the following operations:
determining, in response to a touch operation on the thumbnail map, the target location from the thumbnail map; and
acquiring a playback progress corresponding to the virtual object identifier at the target location in the game video, to obtain the target playback progress.

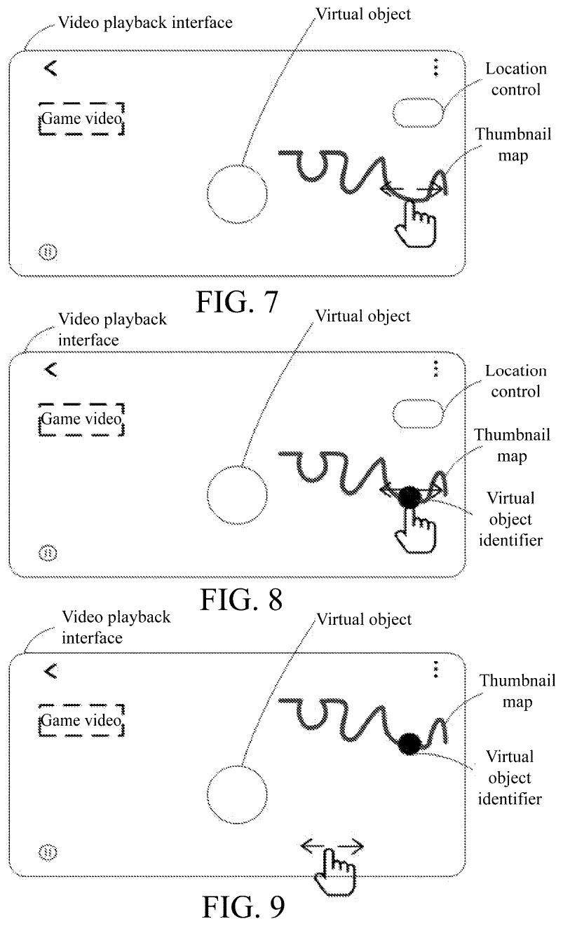

For example, referring to FIG. 7, FIG. 7 is a schematic diagram of an application scenario of another method for adjusting a video progress according to an embodiment of the present disclosure. A virtual object, a game screen of the virtual object, a location control, and a thumbnail map are displayed on a video playback interface shown in FIG. 7. The user can select a target location on the thumbnail map by performing a slide operation on the thumbnail map.

In some embodiments, to facilitate user operation, a virtual object identifier is displayed on the thumbnail map, the location of the virtual object identifier on the thumbnail map corresponds to the location of the virtual object on a virtual race track, and the step of “determining, in response to a touch operation on the thumbnail map, the target location from the thumbnail map” may include the following operation:

determining, in response to a touch operation on the virtual object identifier, the target location of the virtual object identifier on the thumbnail map.

Specifically, the touch operation on the thumbnail map may be a touch operation on the virtual object identifier on the thumbnail map.

For example, referring to FIG. 8, FIG. 8 is a schematic diagram of an application scenario of another method for adjusting a video progress according to an embodiment of the present disclosure. On a video playback interface as shown in FIG. 8, a virtual object identifier is displayed on a thumbnail map. The user may determine a target location of the virtual object identifier on the thumbnail map by sliding the virtual object identifier over the thumbnail map.

In some embodiments, in some embodiments, to improve the accuracy of adjusting the video progress, the step of “determining, in response to a location selection operation on the thumbnail map, and on the basis of a target location selected by the location selection operation, a target playback progress of the game video” may include the following operations:
determining, in response to a touch operation on the video playback interface, the target location from the thumbnail map; and
acquiring a playback progress corresponding to the virtual object identifier at the target location in the game video, to obtain the target playback progress.

For example, referring to FIG. 9, FIG. 9 is a schematic diagram of an application scenario of another method for adjusting a video progress according to an embodiment of the present disclosure. On a video playback interface as shown in FIG. 9, a virtual object, a game screen of the virtual object, and a thumbnail map are displayed. A user can select a target location on the thumbnail map by performing a slide operation on the video playback interface.

In some embodiments, to facilitate user operation, the touch operation on the video playback interface may be a slide operation, that is, a second slide operation, and the step of “determining, in response to a touch operation on the video playback interface, the target location from the thumbnail map” may include the following operations:
determining, in response to a touch operation on the video playback interface, the target location from the thumbnail map includes:
acquiring, in response to the second slide operation on the video playback interface, a slide direction and a slide distance of the second slide operation;
acquiring a current location of the virtual object identifier on the thumbnail map; and
adjusting the current location on the basis of the slide direction and the slide distance of the second slide operation, to obtain the target location.

For example, on the video playback interface as shown in FIG. 9, the second slide operation of the user on the playback progress bar is detected. The slide direction of the second slide operation may be leftward, and the slide distance may be 2 cm.

In an embodiment of the present disclosure, a corresponding relationship between the slide distance of the second slide operation on the video playback interface and a moving distance of the virtual object identifier on the thumbnail map (that is, a calculation formula of the moving distance) may be set in advance, for example, moving distance=slide distance×(total length of thumbnail map/total length of playback progress bar), and the moving distance may be calculated according to the slide distance and the above calculation formula.

Further, the current location of the virtual object identifier on the thumbnail map is moved according to the slide direction and the moving distance, so that the target location of the virtual object identifier on the thumbnail map may be obtained.

Specifically, for the playback progress corresponding to the virtual object identifier at the target location in the game video, a target playback progress may be determined according to a game progress of the virtual object at a game scene corresponding the target location.

Further, the playback progress of the currently playing game video is adjusted to the target playback progress, so that the user can watch the video at a specified progress.

In some embodiments, to prevent other display elements on the video playback interface from blocking the game screen, after the step of “determining a target playback progress of the game video on the basis of a target location selected by the location selection operation”, the method may further include the following step:
hiding the thumbnail map on the video playback interface.

Specifically, after the operation of adjusting the video progress is completed, the thumbnail map is hidden on the video playback interface, and if a playback progress bar is displayed, the playback progress bar is also hidden, so that the user's video watching experience can be improved.

An embodiment of the present disclosure discloses a method for adjusting a video progress. The method includes: displaying a video playback interface including a game screen of a virtual object; displaying a thumbnail map for a virtual race track on the video playback interface, the thumbnail map indicating a virtual race track of the virtual object in a game in a game video; and determining, in response to a location selection operation on the thumbnail map, and on the basis of a target location selected by the location selection operation, a target playback progress of the game video, and adjusting a playback progress of the game video to the target playback progress. Thus, the accuracy of adjusting the video progress can be improved.

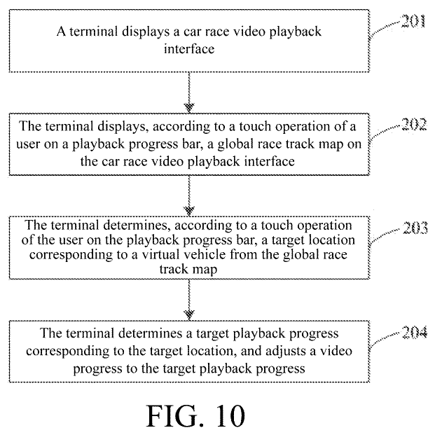

According to the content introduced above, the method for adjusting a video progress of the present disclosure will be further described below by way of example. Referring to FIG. 10, FIG. 10 is a schematic flowchart of another method for adjusting a video progress according to an embodiment of the present disclosure. Said method for adjusting a video progress is specifically applied to adjusting the playback progress of a car race game video as an example, and the specific process may be as follows:

201: A terminal displays a car race video playback interface.

In the embodiment of the present disclosure, a video of a virtual vehicle engaging in a car race game is played on the car race video playback interface. The car race video playback interface includes a racing screen of the virtual vehicle, and a playback progress bar.

Step 202: The terminal displays, according to a touch operation of a user on a playback progress bar, a global race track map on the car race video playback interface.

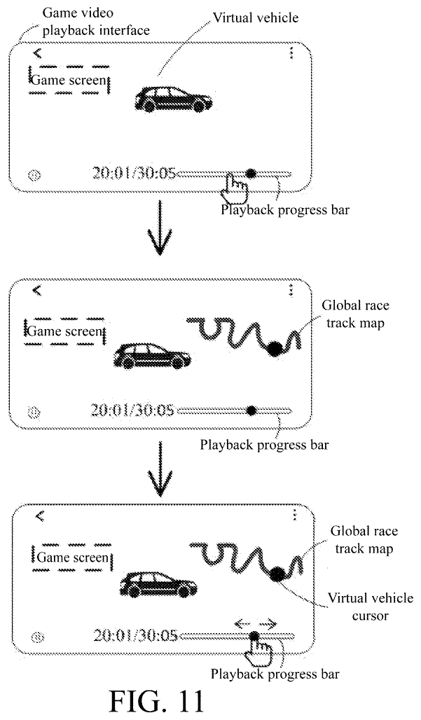

For example, referring to FIG. 11, FIG. 11 is a schematic diagram of an application scenario of another method for adjusting a video progress according to an embodiment of the present disclosure. A game video playback interface as shown in FIG. 11 includes a virtual vehicle, a game screen of the virtual vehicle, and a playback progress bar. When a slide operation of a user on the playback progress bar is detected, a global race track map is displayed on the game video playback interface.

203: The terminal determines, according to a touch operation of the user on the playback progress bar, a target location corresponding to the virtual vehicle from the global race track map.

Continuing to refer to FIG. 11, when a slide operation of the user on the playback progress bar is detected again, a virtual vehicle cursor is controlled to move on the global race track map according to the slide distance and slide direction of the slide operation, thereby determining a target location of the virtual vehicle cursor on the global race track map.

204: The terminal determines a target playback progress corresponding to the target location, and adjusts a video progress to the target playback progress.

Specifically, according to a target race track scene corresponding to the target location, a playback progress corresponding to the target race track scene is determined from the car race video to obtain the target playback progress, and then a current video progress is adjusted to the target playback progress.

An embodiment of the present disclosure discloses a method for adjusting a video progress. The method includes: displaying, by a terminal, a car race video playback interface; displaying, according to a touch operation of a user on a playback progress bar, a global race track map on the car race video playback interface; determining, according to the touch operation of the user on the playback progress bar, a target location corresponding to a virtual vehicle from the global race track map; determining a target playback progress corresponding to the target location; and adjusting a video progress to the target playback progress, which may improve the user's video watching experience.

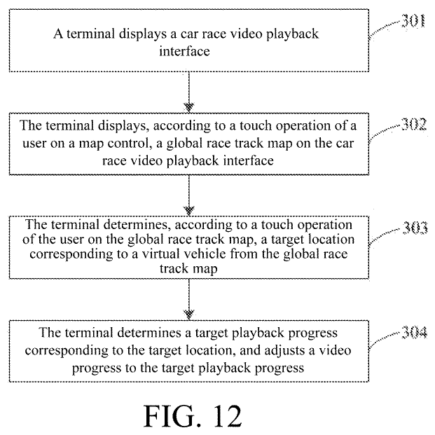

Referring to FIG. 12, FIG. 12 is a schematic flowchart of another method for adjusting a video progress according to an embodiment of the present disclosure. Said method for adjusting a video progress is specifically applied to adjusting the playback progress of a car race game video as an example, and the specific process may be as follows:

301: A terminal displays a car race video playback interface.

In the embodiment of the present disclosure, a video of a virtual vehicle engaging in a car race game is played on the car race video playback interface. The car race video playback interface includes a racing screen of the virtual vehicle, a playback progress bar, and a map control.

302: The terminal displays, according to a touch operation of a user on the map control, a global race track map on the car race video playback interface.

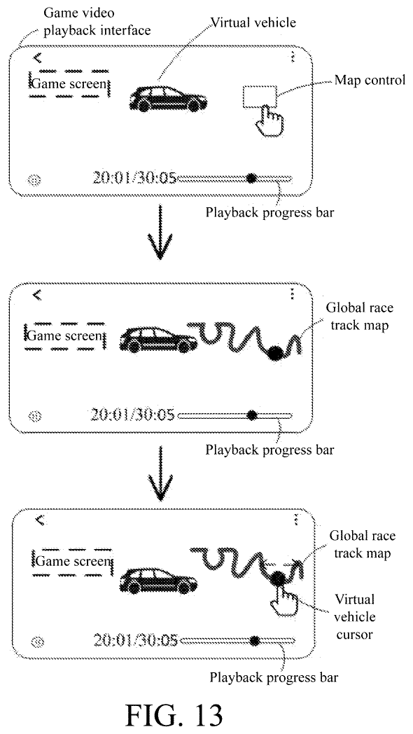

For example, referring to FIG. 13, FIG. 13 is a schematic diagram of an application scenario of another method for adjusting a video progress according to an embodiment of the present disclosure. A game video playback interface as shown in FIG. 13 includes a virtual vehicle, a game screen of the virtual vehicle, and a map control. When a click operation of a user on the map control is detected, a global race track map is displayed on the game video playback interface.

303: The terminal determines, according to a touch operation of the user on the global race track map, a target location corresponding to the virtual vehicle from the global race track map.

Continuing to refer to FIG. 13, when a slide operation of the user on the global race track map is detected, a virtual vehicle cursor is controlled to move on the global race track map according to a slide distance and a slide direction of the slide operation, thereby determining a target location of the virtual vehicle cursor on the global race track map.

304: The terminal determines a target playback progress corresponding to the target location, and adjusts a video progress to the target playback progress.

Specifically, according to a target race track scene corresponding to the target location, a playback progress corresponding to the target race track scene is determined from the car race video to obtain the target playback progress, and then a current video progress is adjusted to the target playback progress.

An embodiment of the present disclosure discloses a method for adjusting a video progress. The method includes: displaying, by a terminal, a car race video playback interface; displaying, according to a touch operation of a user on a map control, a global race track map on the car race video playback interface; determining, according to a touch operation of the user on the global race track map, a target location corresponding to a virtual vehicle from the global race track map; determining a target playback progress corresponding to the target location; and adjusting a video progress to the target playback progress, which can improve the user's video watching experience.

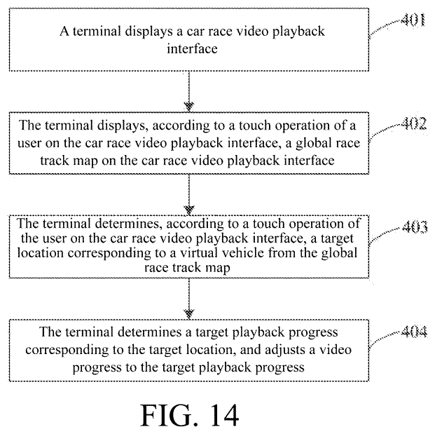

Referring to FIG. 14, FIG. 14 is a schematic flowchart of another method for adjusting a video progress according to an embodiment of the present disclosure. Said method for adjusting a video progress is specifically applied to adjusting the playback progress of a car race game video as an example, and the specific process may be as follows:

401: A terminal displays a car race video playback interface.

In the embodiment of the present disclosure, a video of a virtual vehicle engaging in a car race game is played on the car race video playback interface. The car race video playback interface includes a racing screen of the virtual vehicle, and a playback progress bar.

402: The terminal displays, according to a touch operation of a user on the car race video playback interface, a global race track map on the car race video playback interface.

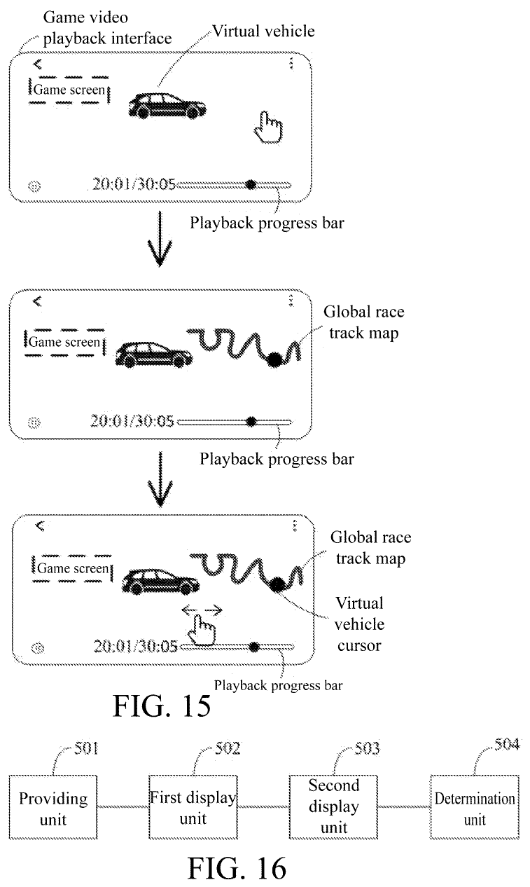

For example, referring to FIG. 15, FIG. 15 is a schematic diagram of an application scenario of another method for adjusting a video progress according to an embodiment of the present disclosure. A game video playback interface as shown in FIG. 15 includes a virtual vehicle, a game screen of the virtual vehicle, and a playback progress bar. When a click operation of a user on the car race video playback interface is detected, a global race track map is displayed on the game video playback interface.

403: The terminal determines, according to a touch operation of the user on the car race video playback interface, a target location corresponding to the virtual vehicle from the global race track map.

Continuing to refer to FIG. 13, when a slide operation of the user on the car race video playback interface is detected, a virtual vehicle cursor is controlled to move on the global race track map according to a slide distance and a slide direction of the slide operation, thereby determining a target location of the virtual vehicle cursor on the global race track map.

404: The terminal determines a target playback progress corresponding to the target location, and adjusts a video progress to the target playback progress.

Specifically, according to a target race track scene corresponding to the target location, a playback progress corresponding to the target race track scene is determined from the car race video to obtain the target playback progress, and then a current video progress is adjusted to the target playback progress.

An embodiment of the present disclosure discloses a method for adjusting a video progress. The method includes: displaying, by a terminal, a car race video playback interface; displaying, according to a touch operation of a user on the car race video playback interface, a global race track map on the car race video playback interface; determining, according to the touch operation of the user on the car race video playback interface, a target location corresponding to a virtual vehicle from the global race track map; determining a target playback progress corresponding to the target location; and adjusting a video progress to the target playback progress, which can improve the user's video watching experience.

To facilitate better implementation of the method for adjusting a video progress provided by the embodiment of the present disclosure, embodiments of the present disclosure further provide an apparatus for adjusting a video progress on the basis of the method for adjusting a video progress. The terms herein have the same meanings as those in the above method for adjusting a video progress, and for specific implementation details, reference may be made to the description in the method embodiments.

Referring to FIG. 16, FIG. 16 is a structural block diagram of an apparatus for adjusting a video progress according to an embodiment of the present disclosure. The apparatus includes:
a providing unit 501 configured to provide a video playback interface;
a first display unit 502 configured to display, on the video playback interface, a game video including a virtual object running in a virtual race track;
a second display unit 503 configured to display a thumbnail map for the virtual race track on the video playback interface; and
a determination unit 504 configured to determine, in response to a location selection operation on the thumbnail map, and on the basis of a target location selected by the location selection operation, a target playback progress of the game video, and adjust a playback progress of the game video to the target playback progress.

In some embodiments, the second display unit 503 may include:
a first display subunit configured to display, in response to a touch operation on the video playback interface, a playback progress bar on the video playback interface;
a second display subunit configured to display, in response to a touch operation on the playback progress bar, the thumbnail map on the video playback interface.

In some embodiments, the determination unit 504 may include:
a first determination subunit configured to determine, in response to a touch operation on the playback progress bar, the target location of the virtual object identifier on the thumbnail map; and
a first acquisition subunit configured to acquire a playback progress corresponding to the virtual object identifier at the target location in the game video, to obtain the target playback progress.

In some embodiments, the first determination subunit may be specifically configured to:
acquire, in response to a first slide operation on the playback progress bar, a slide direction and a slide distance of the first slide operation;
acquire a current location of the virtual object identifier on the thumbnail map; and
adjust the current location on the basis of the slide direction and the slide distance of the first slide operation, to obtain the target location.

In some embodiments, the second display unit 503 may include:
a third display subunit configured to display, in response to a touch operation on the location control, the thumbnail map on the video playback interface.

In some embodiments, the determination unit 504 may include:
a second determination subunit configured to determine, in response to a touch operation on the thumbnail map, the target location from the thumbnail map; and
a second acquisition subunit configured to acquire a playback progress corresponding to the virtual object identifier at the target location in the game video, to obtain the target playback progress.

In some embodiments, the second determination subunit may be specifically configured to:
determine, in response to a touch operation on the virtual object identifier, the target location of the virtual object identifier on the thumbnail map.

In some embodiments, the second display unit 503 may include:
a fourth display subunit configured to display, in response to a touch operation on the video playback interface, the thumbnail map on the video playback interface.

In some embodiments, the determination unit 504 may include:
a third determination subunit configured to determine, in response to a touch operation on the video playback interface, the target location from the thumbnail map; and
a third acquisition subunit configured to acquire a playback progress corresponding to the virtual object identifier at the target location in the game video, to obtain the target playback progress.

In some embodiments, the third determination subunit may be specifically configured to:
acquire, in response to a second slide operation on the video playback interface, a slide direction and a slide distance of the second slide operation;
acquire a current location of the virtual object identifier on the thumbnail map; and
adjust the current location on the basis of the slide direction and the slide distance of the second slide operation to obtain the target location.

In some embodiments, the apparatus may further include:
a hiding unit configured to hide the thumbnail map on the video playback interface.

The embodiments of the present disclosure disclose an apparatus for adjusting a video progress, in which the providing unit 501 provides a video playback interface; the first display unit 502 displays, on the video playback interface, a game video including a virtual object running on a virtual race track; the second display unit 503 displays a thumbnail map for the virtual race track on the video playback interface; and the determination unit 504 determines, in response to a location selection operation on the thumbnail map, and on the basis of a target location selected by the location selection operation, a target playback progress of the game video, and adjusts a playback progress of the game video to the target playback progress. Thus, the accuracy of adjusting the video progress can be improved.

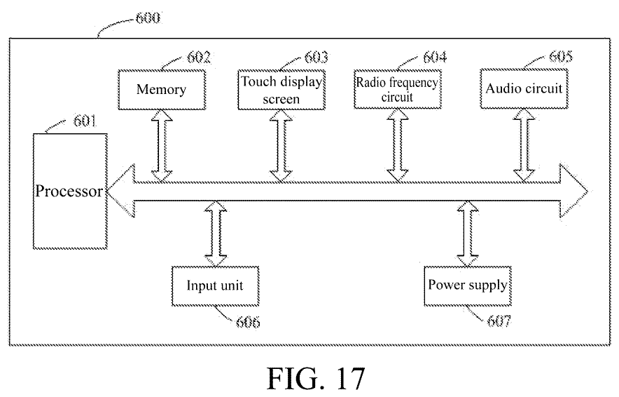

Correspondingly, an embodiment of the present disclosure further provides a computer device. The computer device may be a terminal. As shown in FIG. 17, FIG. 17 is a schematic structural diagram of a computer device according to an embodiment of the present disclosure. The computer device 600 includes a processor 601 having one or more processing cores, a memory 602 having one or more computer-readable storage media, and a computer program stored in the memory 602 and executable on the processor. The processor 601 is electrically connected to the memory 602. It will be appreciated by those skilled in the art that the structure of the computer device shown in the figure does not constitute a limitation of the computer device, and may include more or less components than those shown in the figure, or some components may be combined, or the components are arranged in different manners.

The processor 601 is a control center of the computer device 600, connects various parts of the entire computer device 600 using various interfaces and lines, and performs various functions of the computer device 600 and processes data by executing or loading a software program and/or modules stored in the memory 602, and invoking data stored in the memory 602, thereby performing overall monitoring of the computer device 600.

In the embodiment of the present disclosure, the processor 601 in the computer device 600 loads instructions corresponding to processes of one or more application programs into the memory 602 according to the following steps, and the processor 601 executes the application programs stored in the memory 602, thereby implementing various functions:
providing a video playback interface;
displaying, on the video playback interface, a game video including a virtual object running on a virtual race track;
displaying a thumbnail map for the virtual race track on the video playback interface; and
determining, in response to a location selection operation on the thumbnail map, and on the basis of a target location selected by the location selection operation, a target playback progress of the game video, and adjusting a playback progress of the game video to the target playback progress.

In some embodiments, displaying a thumbnail map for the virtual race track on the video playback interface includes:
displaying, in response to a touch operation on the video playback interface, a playback progress bar on the video playback interface; and
displaying, in response to a touch operation on the playback progress bar, the thumbnail map on the video playback interface.

In some embodiments, a virtual object identifier is displayed on the thumbnail map, and the location of the virtual object identifier on the thumbnail map corresponds to the location of the virtual object on the virtual race track.

Determining, in response to a location selection operation on the thumbnail map, and on the basis of a target location selected by the location selection operation, a target playback progress of the game video includes:
determining, in response to a touch operation on the playback progress bar, a target location of a virtual object identifier on the thumbnail map; and
acquiring a playback progress corresponding to the virtual object identifier at the target location in the game video, to obtain the target playback progress.

In some embodiments, the touch operation on the playback progress bar includes a first slide operation.

Determining, in response to a touch operation on the playback progress bar, a target location of a virtual object identifier on the thumbnail map includes:
acquiring, in response to the first slide operation on the playback progress bar, a slide direction and a slide distance of the first slide operation;
acquiring a current location of the virtual object identifier on the thumbnail map; and
adjusting the current location on the basis of the slide direction and the slide distance of the first slide operation, to obtain the target location.

In some embodiments, the video playback interface includes a location control.

Displaying a thumbnail map for the virtual race track on the video playback interface includes:
displaying, in response to a touch operation on a location control, the thumbnail map on the video playback interface.

In some embodiments, determining, in response to a location selection operation on the thumbnail map, and on the basis of a target location selected by the location selection operation, a target playback progress of the game video includes:
determining, in response to a touch operation on the thumbnail map, the target location from the thumbnail map; and
acquiring a playback progress corresponding to the virtual object identifier at the target location in the game video, to obtain the target playback progress.

In some embodiments, a virtual object identifier is displayed on the thumbnail map, and the location of the virtual object identifier on the thumbnail map corresponds to the location of the virtual object on the virtual race track.

Determining, in response to a touch operation on the thumbnail map, the target location from the thumbnail map includes:
determining, in response to a touch operation on the virtual object identifier, the target location of the virtual object identifier on the thumbnail map.

In some embodiments, displaying a thumbnail map for the virtual race track on the video playback interface includes:
displaying, in response to a touch operation on the video playback interface, the thumbnail map on the video playback interface.

In some embodiments, determining, in response to a location selection operation on the thumbnail map, and on the basis of a target location selected by the location selection operation, a target playback progress of the game video includes:
determining, in response to a touch operation on the video playback interface, the target location from the thumbnail map; and
acquiring a playback progress corresponding to the virtual object identifier at the target location in the game video, to obtain the target playback progress.

In some embodiments, the touch operation on the video playback interface includes a second slide operation.

Determining, in response to a touch operation on the video playback interface, the target location from the thumbnail map includes:
acquiring, in response to the second slide operation on the video playback interface, a slide direction and a slide distance of the second slide operation;
acquiring a current location of the virtual object identifier on the thumbnail map; and
adjusting the current location on the basis of the slide direction and the slide distance of the second slide operation, to obtain the target location.

In some embodiments, after the step of determining a target playback progress of the game video on the basis of a target location selected by the location selection operation, the method further includes:
hiding the thumbnail map on the video playback interface.

In this solution, the global thumbnail map is provided on the video playback interface, and the target playback progress of the game video is determined by the touch operation of the user on the video playback interface, the video playback progress bar, or the global thumbnail map, so that the current video playback progress is adjusted on the basis of the target playback progress, helping the user to quickly navigate to a video segment that the user wants to watch, and improving the efficiency of video progress adjustment.

For specific implementation of the above operations, reference may be made to the foregoing embodiments, and details are not described herein again.

In some examples, as shown in FIG. 17, the computer device 600 further includes: a touch display screen 603, a radio frequency circuit 604, an audio circuit 605, an input unit 606, and a power supply 607. The processor 601 is separately electrically connected to the touch display screen 603, the radio frequency circuit 604, the audio circuit 605, the input unit 606, and the power supply 607. It will be appreciated by those skilled in the art that the structure of the computer device shown in FIG. 17 does not constitute a limitation of the computer device, and may include more or less components than those shown in the figure, or some components may be combined, or the components are arranged in different manners.

The touch display screen 603 may be configured to display a graphical user interface and receive operation instructions generated by a user acting on the graphical user interface. The touch display screen 603 may include a display panel and a touch panel. The display panel may be configured to display information entered by or provided to a user as well as various graphical user interfaces of the computer device, which may be composed of graphics, text, icons, videos, and any combination thereof. In some examples, the display panel may be configured in the form of a liquid crystal display (LCD), an organic light-emitting diode (OLED), or the like. The touch panel may be configured to acquire a touch operation of the user on or near the touch panel (e.g., an operation on or near the touch panel by the user using any suitable object or accessory such as a finger, a stylus, etc.), and generate corresponding operation instructions, and the operation instructions implement corresponding programs. In some examples, the touch panel may include two parts: a touch detection apparatus and a touch controller. The touch detection apparatus detects a touch orientation of the user, detects a signal caused by the touch operation, and transmits the signal to the touch controller. The touch controller receives touch information from the touch detection apparatus, converts the touch information into contact coordinates, then sends the contact coordinates to the processor 601, and can receive and execute a command from the processor 601. The touch panel may cover the display panel. When the touch panel detects the touch operation on or near the touch panel, the touch panel transmits the touch operation to the processor 601 to determine the type of a touch event, and then the processor 601 provides a corresponding visual output on the display panel according to the type of the touch event. In the embodiment of the present disclosure, input and output functions may be implemented by integrating the touch panel and the display panel into the touch display screen 603. In some embodiments, however, the touch panel and the touch panel may be two separate components to perform input and output functions. That is, the touch display screen 603 may also serve as a part of the input unit 606 to implement the input function.

The radio frequency circuit 604 may be configured to transmit and receive radio frequency signals, so as to establish wireless communication with a network device or other computer devices via wireless communication, and transmit and receive signals to and from the network device or other computer devices.

The audio circuit 605 may be configured to provide an audio interface between a user and the computer device through a speaker, a microphone, or the like. The audio circuit 605 may transmit, to the speaker, an electrical signal obtained by converting received audio data, and the electrical signal is converted by the speaker into a sound signal for output. On the other hand, the microphone converts the acquired sound signal into an electrical signal. The electrical signal is received by the audio circuit 605 and then converted into audio data. The audio data is then output to the processor 601 for processing, and the processed audio data is transmitted to, for example, another computer device via the radio frequency circuit 604, or the audio data is output to the memory 602 for further processing. The audio circuit 605 may further include an earphone jack to provide communication between an external earphone and the computer device.

The input unit 606 may be configured to receive input numbers, character information, or user feature information (e.g., fingerprints, iris, facial information, etc.), and generate keyboard, mouse, joystick, optical, or trackball signal inputs related to user settings and function control.

The power supply 607 is configured to supply power to various components of the computer device 600. In some examples, the power supply 607 may be logically connected to the processor 601 through a power management system, so that functions such as management of charging and discharging, and power consumption management are implemented by means of the power management system. The power supply 607 may further include one or more DC or AC power supplies, a recharging system, a power failure detection circuit, a power converter or inverter, a power status indicator, and any of other components.

Although not shown in FIG. 17, the computer device 600 may further include a camera, a sensor, a wireless fidelity module, a Bluetooth module, and the like, and details are not described in detail herein.

In the above embodiments, each embodiment has been described with emphasis on a different part, and for parts not described in detail in a certain embodiment, reference may be made to related descriptions in other embodiments.

As can be seen from the foregoing, the computer device provided in this embodiment may be configured to: provide a video playback interface; display, on the video playback interface, a game video including a virtual object running on a virtual race track; display a thumbnail map for the virtual race track on the video playback interface; and determine, in response to a location selection operation on the thumbnail map, and on the basis of a target location selected by the location selection operation, a target playback progress of the game video, and adjust a playback progress of the game video to the target playback progress.

It will be appreciated by those of ordinary skill in the art that all or part of the steps in the various methods of the above embodiments may be implemented by instructions, or by instructions controlling related hardware, and the instructions may be stored in a computer-readable storage medium and loaded and executed by a processor.

To this end, an embodiment of the present disclosure provides a computer-readable storage medium, in which a plurality of computer programs are stored. The computer programs can be loaded by a processor, so as to perform the steps in any one of the methods for adjusting a video progress provided by the embodiments of the present disclosure. For example, the computer program may perform the following steps:
providing a video playback interface;
displaying, on the video playback interface, a game video including a virtual object running on a virtual race track;
displaying a thumbnail map for the virtual race track on the video playback interface; and
determining, in response to a location selection operation on the thumbnail map, and on the basis of a target location selected by the location selection operation, a target playback progress of the game video, and adjusting a playback progress of the game video to the target playback progress.

In some embodiments, displaying a thumbnail map for the virtual race track on the video playback interface includes:
displaying, in response to a touch operation on the video playback interface, a playback progress bar on the video playback interface; and
displaying, in response to a touch operation on the playback progress bar, the thumbnail map on the video playback interface.

In some embodiments, a virtual object identifier is displayed on the thumbnail map, and the location of the virtual object identifier on the thumbnail map corresponds to the location of the virtual object on the virtual race track.

Determining, in response to a location selection operation on the thumbnail map, and on the basis of a target location selected by the location selection operation, a target playback progress of the game video includes:
determining, in response to a touch operation on the playback progress bar, a target location of a virtual object identifier on the thumbnail map; and
acquiring a playback progress corresponding to the virtual object identifier at the target location in the game video, to obtain the target playback progress.

In some embodiments, the touch operation on the playback progress bar includes a first slide operation.

Determining, in response to a touch operation on the playback progress bar, a target location of a virtual object identifier on the thumbnail map includes:
acquiring, in response to the first slide operation on the playback progress bar, a slide direction and a slide distance of the first slide operation;
acquiring a current location of the virtual object identifier on the thumbnail map; and
adjusting the current location on the basis of the slide direction and the slide distance of the first slide operation, to obtain the target location.

In some embodiments, the video playback interface includes a location control.

Displaying a thumbnail map for the virtual race track on the video playback interface includes:
displaying, in response to a touch operation on a location control, the thumbnail map on the video playback interface.

In some embodiments, determining, in response to a location selection operation on the thumbnail map, and on the basis of a target location selected by the location selection operation, a target playback progress of the game video includes:
determining, in response to a touch operation on the thumbnail map, the target location from the thumbnail map; and
acquiring a playback progress corresponding to the virtual object identifier at the target location in the game video, to obtain the target playback progress.

In some embodiments, a virtual object identifier is displayed on the thumbnail map, and the location of the virtual object identifier on the thumbnail map corresponds to the location of the virtual object on the virtual race track.

Determining, in response to a touch operation on the thumbnail map, the target location from the thumbnail map includes:
determining, in response to a touch operation on the virtual object identifier, the target location of the virtual object identifier on the thumbnail map.

In some embodiments, displaying a thumbnail map for the virtual race track on the video playback interface includes:
displaying, in response to a touch operation on the video playback interface, the thumbnail map on the video playback interface.

In some embodiments, determining, in response to a location selection operation on the thumbnail map, and on the basis of a target location selected by the location selection operation, a target playback progress of the game video includes:
determining, in response to a touch operation on the video playback interface, the target location from the thumbnail map; and
acquiring a playback progress corresponding to the virtual object identifier at the target location in the game video, to obtain the target playback progress.

In some embodiments, the touch operation on the video playback interface includes a second slide operation.

Determining, in response to a touch operation on the video playback interface, the target location from the thumbnail map includes:
acquiring, in response to the second slide operation on the video playback interface, a slide direction and a slide distance of the second slide operation;
acquiring a current location of the virtual object identifier on the thumbnail map; and
adjusting the current location on the basis of the slide direction and the slide distance of the second slide operation, to obtain the target location.

In some embodiments, after the step of determining a target playback progress of the game video on the basis of a target location selected by the location selection operation, the method further includes:
hiding the thumbnail map on the video playback interface.

In this solution, the global thumbnail map is provided on the video playback interface, and the target playback progress of the game video is determined by the touch operation of the user on the video playback interface, the video playback progress bar, or the global thumbnail map, so that the current video playback progress is adjusted on the basis of the target playback progress, helping the user to quickly navigate to a video segment that the user wants to watch, and improving the efficiency of video progress adjustment.

For specific implementation of the above operations, reference may be made to the foregoing embodiments, and details are not described herein again.

The storage medium may include: a read only memory (ROM), a random access memory (RAM), a magnetic disk, an optical disk, or the like.

Since the computer program stored in the storage medium can execute the steps of any one of the methods for adjusting a video progress provided by the embodiments of the present disclosure, it is possible to achieve the advantageous effects that can be achieved by any one of the methods for adjusting a video progress provided in the embodiments of the present disclosure. Reference can be made to the foregoing embodiments for details, which are not described herein again.

The method and apparatus for adjusting a video progress, the storage medium, and the computer device provided by the embodiments of the present disclosure have been described in detail above, and the principles and implementation manners of the present disclosure have been described herein by using specific examples. The description of the above embodiments is only used to help understand the method and the core concept of the present disclosure. Also, for those skilled in the art, each of the specific implementation manners and application ranges may be changed in accordance with the concept of the present disclosure. In summary, the content of the present description should not be construed as limiting the present disclosure.

1. A method for adjusting a video progress, comprising:
providing a video playback interface;
displaying, on the video playback interface, a game video including a virtual object running on a virtual race track;
displaying a thumbnail map for the virtual race track on the video playback interface;
determining, in response to a location selection operation on the thumbnail map, and on the basis of a target location selected by the location selection operation, a target playback progress of the game video; and
adjusting a playback progress of the game video to the target playback progress.

2. The method according to claim 1, wherein displaying the thumbnail map for the virtual race track on the video playback interface comprises:
displaying, in response to a touch operation on the video playback interface, a playback progress bar on the video playback interface; and
displaying, in response to a touch operation on the playback progress bar, the thumbnail map on the video playback interface.

3. The method according to claim 2, wherein a virtual object identifier is displayed on the thumbnail map, wherein a location of the virtual object identifier on the thumbnail map corresponds to a location of the virtual object on the virtual race track, and
wherein determining, in response to the location selection operation on the thumbnail map, and on the basis of the target location selected by the location selection operation, the target playback progress of the game video comprises:
determining, in response to the touch operation on the playback progress bar, the target location of the virtual object identifier on the thumbnail map; and
acquiring a playback progress corresponding to the virtual object identifier at the target location in the game video, to obtain the target playback progress.

4. The method according to claim 3, wherein the touch operation on the playback progress bar comprises a first slide operation, and
wherein determining, in response to the touch operation on the playback progress bar, the target location of the virtual object identifier on the thumbnail map comprises:
acquiring, in response to the first slide operation on the playback progress bar, a slide direction and a slide distance of the first slide operation;
acquiring a current location of the virtual object identifier on the thumbnail map; and
adjusting the current location on the basis of the slide direction and the slide distance of the first slide operation, to obtain the target location.

5. The method according to claim 1, wherein the video playback interface comprises a location control, and
wherein displaying the thumbnail map for the virtual race track on the video playback interface comprises:
displaying, in response to a touch operation on the location control, the thumbnail map on the video playback interface.

6. The method according to claim 5, wherein determining, in response to the location selection operation on the thumbnail map, and on the basis of the target location selected by the location selection operation, the target playback progress of the game video comprises:
determining, in response to a touch operation on the thumbnail map, the target location from the thumbnail map; and
acquiring a playback progress corresponding to the virtual object identifier at the target location in the game video, to obtain the target playback progress.

7. The method according to claim 6, wherein the virtual object identifier is displayed on the thumbnail map, wherein a location of the virtual object identifier on the thumbnail map corresponds to a location of the virtual object in the virtual race track, and
wherein determining, in response to the touch operation on the thumbnail map, the target location from the thumbnail map comprises:
determining, in response to a touch operation on the virtual object identifier, the target location of the virtual object identifier on the thumbnail map.

8. The method according to claim 1, wherein displaying the thumbnail map for the virtual race track on the video playback interface comprises:
displaying, in response to a touch operation on the video playback interface, the thumbnail map on the video playback interface.

9. The method according to claim 8, wherein determining, in response to the location selection operation on the thumbnail map, and on the basis of the target location selected by the location selection operation, the target playback progress of the game video comprises:
determining, in response to the touch operation on the video playback interface, the target location from the thumbnail map; and
acquiring a playback progress corresponding to the virtual object identifier at the target location in the game video, to obtain the target playback progress.

10. The method according to claim 9, wherein the touch operation on the video playback interface comprises a second slide operation, and
wherein determining, in response to the touch operation on the video playback interface, the target location from the thumbnail map comprises:
acquiring, in response to the second slide operation on the video playback interface, a slide direction and a slide distance of the second slide operation;
acquiring a current location of the virtual object identifier on the thumbnail map; and
adjusting the current location on the basis of the slide direction and the slide distance of the second slide operation to obtain the target location.

11. The method according to claim 1, the method further comprises:
hiding the thumbnail map on the video playback interface.

12. (canceled)

13. A system, comprising:
one or more processors;
one or more memories storing computer-executable instructions, which, when executed on any combination of the one or more processors, performs operations, the operations comprising:
providing a video playback interface;
displaying, on the video playback interface, a game video including a virtual object running on a virtual race track;
displaying a thumbnail map for the virtual race track on the video playback interface; and
determining, in response to a location selection operation on the thumbnail map, and on the basis of a target location selected by the location selection operation, a target playback progress of the game video; and
adjusting a playback progress of the game video to the target playback progress.

14. A non-transitory computer-readable storage medium, wherein the storage medium stores a plurality of instructions adapted to be loaded by one or more processors collectively or individually, to perform operations, the operations comprising:
providing a video playback interface;
displaying, on the video playback interface, a game video including a virtual object running on a virtual race track;
displaying a thumbnail map for the virtual race track on the video playback interface;
determining, in response to a location selection operation on the thumbnail map, and on the basis of a target location selected by the location selection operation, a target playback progress of the game video; and
adjusting a playback progress of the game video to the target playback progress.

15. The non-transitory computer-readable storage medium according to claim 14, wherein displaying the thumbnail map for the virtual race track on the video playback interface comprises:
displaying, in response to a touch operation on the video playback interface, a playback progress bar on the video playback interface; and
displaying, in response to a touch operation on the playback progress bar, the thumbnail map on the video playback interface.

16. The non-transitory computer-readable storage medium according to claim 15, wherein a virtual object identifier is displayed on the thumbnail map, wherein a location of the virtual object identifier on the thumbnail map corresponds to a location of the virtual object on the virtual race track; and
wherein determining, in response to the location selection operation on the thumbnail map, and on the basis of the target location selected by the location selection operation, the target playback progress of the game video comprises:
determining, in response to the touch operation on the playback progress bar, the target location of the virtual object identifier on the thumbnail map; and
acquiring a playback progress corresponding to the virtual object identifier at the target location in the game video, to obtain the target playback progress.

17. The non-transitory computer-readable storage medium according to claim 16, wherein the touch operation on the playback progress bar comprises a first slide operation, and
wherein determining, in response to the touch operation on the playback progress bar, the target location of the virtual object identifier on the thumbnail map comprises:
acquiring, in response to the first slide operation on the playback progress bar, a slide direction and a slide distance of the first slide operation;
acquiring a current location of the virtual object identifier on the thumbnail map; and
adjusting the current location on the basis of the slide direction and the slide distance of the first slide operation, to obtain the target location.

18. The non-transitory computer-readable storage medium according to claim 15, wherein the video playback interface comprises a location control, and
wherein displaying the thumbnail map for the virtual race track on the video playback interface comprises:
displaying, in response to a touch operation on the location control, the thumbnail map on the video playback interface.

19. The non-transitory computer-readable storage medium according to claim 18, wherein determining, in response to the location selection operation on the thumbnail map, and on the basis of the target location selected by the location selection operation, the target playback progress of the game video comprises:
determining, in response to a touch operation on the thumbnail map, the target location from the thumbnail map; and
acquiring a playback progress corresponding to the virtual object identifier at the target location in the game video, to obtain the target playback progress.

20. The non-transitory computer-readable storage medium according to claim 19, wherein the virtual object identifier is displayed on the thumbnail map, wherein a location of the virtual object identifier on the thumbnail map corresponds to a location of the virtual object on the virtual race track, and
wherein determining, in response to the touch operation on the thumbnail map, the target location from the thumbnail map comprises:
determining, in response to a touch operation on the virtual object identifier, the target location of the virtual object identifier on the thumbnail map.

21. The system of claim 13, wherein the video playback interface comprises a location control,
wherein displaying the thumbnail map for the virtual race track on the video playback interface comprises:
displaying, in response to a touch operation on the location control, the thumbnail map on the video playback interface,
wherein the virtual object identifier is displayed on the thumbnail map,
wherein a location of the virtual object identifier on the thumbnail map corresponds to a location of the virtual object in the virtual race track, and
wherein determining the target playback progress of the game video comprises:
determining, in response to a touch operation on the virtual object identifier, the target location of the virtual object identifier on the thumbnail map; and
acquiring a playback progress corresponding to the virtual object identifier at the target location in the game video, to obtain the target playback progress.
